(19) United States
(12) Patent Application Publication
(10) Pub. No.: US 2023/0273589 A1
(43) Pub. Date: Aug. 31, 2023

(54) METHOD, DEVICE, AND APPARATUS FOR ASSEMBLING PRISMS

(71) Applicant: IVIEW DISPLAYS (SHENZHEN) COMPANY LTD., Shenzhen (CN)

(72) Inventors: Xiong Zhou, Shenzhen (CN); Liang Mei, Shenzhen (CN); Mingnei Ding, Shenzhen (CN); Steve Yeung, Hongkong (CN); Zhiqiang Gao, Hongkong (CN)

(21) Appl. No.: 18/311,972

(22) Filed: May 4, 2023

Related U.S. Application Data
(63) Continuation of application No. PCT/CN2021/100652, filed on Jun. 17, 2021.

(30) Foreign Application Priority Data
Apr. 14, 2021 (CN) 202110400924.0

(51) Int. Cl. G05B 19/4097; G06T 17/00; G06T 7/70; G06T 1/00

(52) U.S. Cl. CPC G05B 19/4097; G06T 17/00; G06T 7/70; G06T 1/0014; G02B 5/04

(57) ABSTRACT

The present application provides a method, a device, and an apparatus for assembling a prism. The method includes: acquiring scanned data by scanning a space where the prism and the fitting body are disposed in response to the prism being placed at a first predetermined station and the fitting body being placed at a second predetermined station; generating a physical 3D model by three-dimensional reconstruction on the prism, the fitting body, and the space based on the scanned data; acquiring comparison data by comparing the physical 3D model with a theoretic 3D model, wherein the theoretic 3D model is a theoretic model for fitting the prism to the fitting body; and controlling, based on the comparison data, a manipulator to fit the prism at the first predetermined station to the fitting body at the second predetermined station.

### CROSS-REFERENCE TO RELATED APPLICATIONS

This application is a continuation-application of International (PCT) Patent Application No. PCT/CN2021/100652, filed on Jul. 17, 2021, which claims priority to Chinese Patent Application No. 202110400924.0 filed with the National Intellectual Property Administration of China on Apr. 14, 2021, and entitled “METHOD, DEVICE, AND APPARATUS FOR ASSEMBLING PRISMS”, the entire contents of which are incorporated herein by reference.

### TECHNICAL FIELD

Embodiments of the present disclosure relate to the technical field of assembling prisms, and in particular, relate to a method, a device, and an apparatus for assembling a prism.

### BACKGROUND

A prism, also called a triangular prism, is an optical apparatus made of a transparent material, which has a triangular cross section. Among various optical instruments, the prism is configured to decompose compound light into spectrum or change a direction of light. During use, the prism often needs to be fitted to a fitting body. In this way, stability of the prism is maintained, and thus accuracy of the prism is ensured. In addition, friction or collision caused by an external object to the prism may be effectively avoided, and thus normal functions of the prism are effectively protected.

During practice of the present disclosure, the present inventors have found that: at present, in a conventional method, the prism is manually assembled to the fitting body, and thus assembling efficiency is poor and yield of products is low.

### SUMMARY

An aspect of the embodiments of the present disclosure provides a method for assembling a prism, applicable to assembling the prism to a fitting body. The method includes acquiring scanned data by scanning a space where the prism and the fitting body are disposed in response to the prism being placed at a first predetermined station and the fitting body being placed at a second predetermined station; generating a physical 3D model by three-dimensional reconstruction on the prism, the fitting body, and the space based on the scanned data; acquiring comparison data by comparing the physical 3D model with a theoretical 3D model, wherein the theoretical 3D model is a theoretical model for fitting the prism to the fitting body; and controlling, based on the comparison data, a manipulator to fit the prism at the first predetermined station to the fitting body at the second predetermined station.

Another aspect of the embodiments of the present disclosure provides a device for assembling a prism, applicable to assembling the prism to a fitting body. The device includes an acquiring module, configured to acquire scanned data by scanning a space where the prism and the fitting body are disposed in response to the prism being placed at a first predetermined station and the fitting body being placed at a second predetermined station; a model generating module, configured to generate a physical 3D model by three-dimensional reconstruction on the prism, the fitting body, and the space based on the scanned data; a comparing module, configured to acquire comparison data by comparing the physical 3D model with a theoretical 3D model, wherein the theoretical 3D model is a theoretical model for fitting the prism to the fitting body; and an assembling module, configured to control, based on the comparison data, a manipulator to fit the prism at the first predetermined station to the fitting body at the second predetermined station.

Still another aspect of the embodiments of the present disclosure provides an apparatus for assembling a prism, configured to assemble the prism to a fitting body. The apparatus includes: a manipulator, configured to grasp the prism; a motorized unit, connected to the manipulator, and configured to drive the manipulator to fit the prism at a first predetermined station to the fitting body at a second predetermined station; a scanner, configured to scan the space where the prism and the fitting body are disposed; at least one processor, connected to both the motorized unit and the scanner, wherein the at least one processor is configured to control the motorized unit to drive the manipulator to fit the prism to the fitting body, and control the scanner to scan the space where the prism and the fitting body are disposed; and a memory, communicably connected to the at least one processor, wherein the memory stores one or more instructions executable by the at least one processor, wherein, the one or more instructions, when executed by the at least one processor, cause the at least one processor to perform the method for assembling a prism.

### BRIEF DESCRIPTION OF THE DRAWINGS

One or more embodiments are illustrated by way of example, and not by limitation, in the accompanying drawings, wherein components having the same reference numeral designations represent like components throughout. The drawings are not to scale, unless otherwise disclosed.

FIG. 1 is a schematic flowchart of a method for assembling a prism according to an embodiment of the present disclosure.

FIG. 2 is a schematic flowchart of a method for acquiring scanned data according to an embodiment of the present disclosure.

FIG. 3 is a schematic flowchart of a method for acquiring comparison data according to an embodiment of the present disclosure.

FIG. 4 is a schematic flowchart of a method for controlling a manipulator to assemble a prism to a fitting body according to an embodiment of the present disclosure.

FIG. 5 is a schematic flowchart of another method for assembling a prism according to an embodiment of the present disclosure.

FIG. 6 is a schematic diagram of a device for assembling a prism according to an embodiment of the present disclosure.

FIG. 7 is a schematic diagram of an apparatus for assembling a prism according to an embodiment of the present disclosure.

FIG. 8 is a schematic diagram illustrating connections between a processor, a motorized unit, and a scanner according to an embodiment of the present disclosure.

FIG. 9 is a schematic diagram of a processor and a memory being connected to a bus according to an embodiment of the present disclosure.

FIG. 10 is a schematic diagram illustrating a prism assembled to the fitting body according to an embodiment of the present disclosure.

FIG. 11 is a schematic diagram illustrating details of a manipulator and a motorized unit according to an embodiment of the present disclosure.

### DETAILED DESCRIPTION

For clearer descriptions of the objectives, technical solutions, and advantages of the embodiments of the present disclosure, the following clearly and completely describes the technical solutions in the embodiments of the present disclosure with reference to the accompanying drawings in the embodiments of the present disclosure. Apparently, the described embodiments are merely a part rather than all of the embodiments of the present disclosure. It should be understood that, the specific embodiments described herein are only intended to explain the present disclosure instead of limiting the present disclosure. Based on the embodiments of the present disclosure, all other embodiments derived by persons of ordinary skill in the art without any creative efforts shall fall within the protection scope of the present disclosure.

It should be noted that, when an element is defined as “being secured or fixed to” another element, the element may be directly positioned on the element or one or more centered elements may be present therebetween. When an element is defined as “being connected or coupled to” another element, the element may be directly connected or coupled to the element or one or more centered elements may be present therebetween. As used herein, the terms “vertical,” “horizontal,” “left,” “right,” and similar expressions are for illustration purposes.

In addition, technical features involved in various embodiments of the present disclosure described hereinafter may be combined as long as these technical features are not in conflict.

Referring to FIG. 1, FIG. 1 is a schematic flowchart of a method for assembling a prism according to an embodiment of the present disclosure. The method includes the following operations.

In operation S10, scanned data is acquired by scanning a space where the prism and the fitting body are disposed in response to the prism being placed at a first predetermined station and the fitting body being placed at a second predetermined station.

The first predetermined station is configured to place the prism, and the second predetermined station is configured to place the fitting body.

It should be noted that, in some embodiments, in order to facilitate the assembly of the prism to the fitting body, the first predetermined station is disposed to be horizontal to the second predetermined station.

Nevertheless, the first predetermined station and the second predetermined station may not be disposed horizontally, that is, accuracy of the first predetermined station and the second predetermined station is not strictly required, and configuration of the first predetermined station and the second predetermined station is simple.

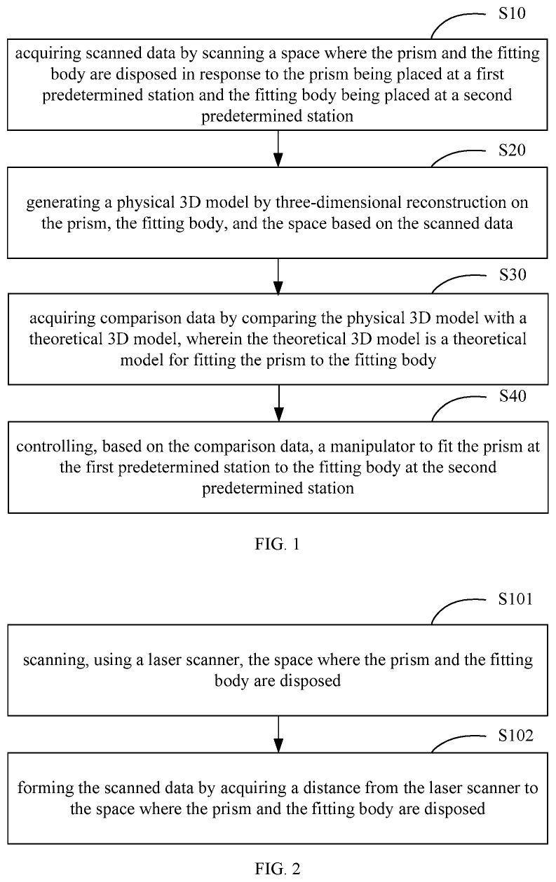

It should be noted that, in some embodiments, referring to FIG. 2, operation S10 further includes the following suboperations.

In suboperation S101, the space where the prism and the fitting body are disposed is scanned using a laser scanner.

The laser scanner is an optical distance sensor, and is capable of emitting light. When the laser scanner is connected to a processor, a distance between the laser scanner and a scanned object is acquired according to a length of the light emitting from the laser scanner between the laser scanner and the scanned object.

It should be noted that, the laser scanner scans a space where the prism and the fitting body are disposed. To be specific, the laser scanner scans the prism at the first predetermined station, the fitting body at the second predetermined station, and a blank area between the prism and the fitting body.

In suboperation S102, the scanned data is formed by acquiring a distance from the laser scanner to the space where the prism and the fitting body are disposed.

The scanned data includes the distance from the laser scanner to the space where the prism and the fitting body are disposed.

It may be understood that, the distance from the laser scanner to the space where the prism and the fitting body are disposed is a series of data. The data includes distances from the laser scanner to a plurality of sites on the prism, to a plurality of sites on the fitting body, and to a plurality of sites on the blank area between the prism and the fitting body.

It may be understood that, the more data of the distance from the laser scanner to the space where the prism and the fitting body are disposed, the higher accuracy of the prism assembly in the later stage based on the scanned data.

In operation S20, a physical 3D model is generated by three-dimensional reconstruction on the prism, the fitting body, and the space based on the scanned data.

In some embodiments, operation S20 further includes: generating the physical 3D model in accordance with an inverse imaging principle by three-dimensional reconstruction on the prism, the fitting body, and the space based on the distance from the laser scanner to the space where the prism and the fitting body are disposed.

It should be noted that, the physical 3D model in accordance with the inverse imaging principle is constructed at a view angle different from view angles of the prism at the first predetermined station, the fitting body at the second predetermined station, and the space where the prism and the fitting body are disposed in reality, and thus the generated physical 3D model may be rotated, such that the generated physical 3D model is at the same view angle as the view angles of the prism at the first predetermined station, the fitting body at the second predetermined station, and the space where the prism and the fitting body are disposed in reality.

It should be noted that, in some embodiments, the scanned data not only includes the distance from the laser scanner to the space where the prism and the fitting body are disposed, but also includes information of an angle of light emitted from the laser scanner; and in this case, generating the physical 3D model by three-dimensional reconstruction on the prism, the fitting body, and the space based on the scanned data includes: imaging the physical 3D model based on the distance from the laser scanner to the space where the prism and the fitting body are disposed, and the information of the angle of the light emitted from the laser scanner.

In operation S30, the comparison data is acquired by comparing the physical 3D model with the theoretical 3D model, wherein the theoretical 3D model is a theoretical model for fitting the prism to the fitting body.

The theoretical 3D model shows the state after the prism is fitted to the fitting body, and the physical 3D model shows, with respect to the fitting body, the state before the prism is fitted to the fitting body. By comparing the states of the fitting body before and after the prism is fitted, the manipulator may be guided to fit the prism to the fitting body in a correct position.

The theoretical 3D model is a theoretical model for fitting the prism to the fitting body.

For example, before production and processing of the prism and the fitting body, a 3D model of the prism and the fitting body is often drawn, and the prism is fitted to the fitting body in the 3D model, such that theoretical 3D model is constructed.

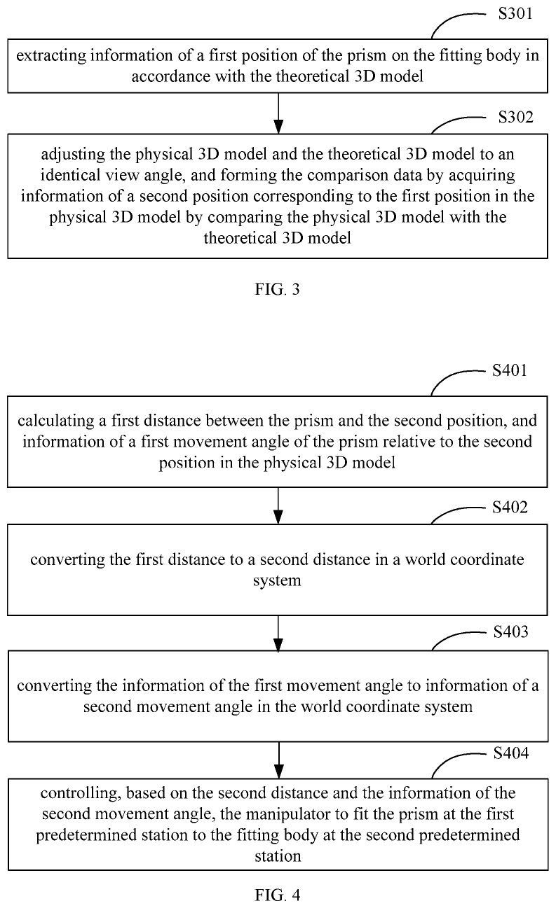

In some embodiments, referring to FIG. 3, operation S30 specifically includes the following suboperations.

In suboperation S301, information of a first position of the prism on the fitting body is extracted in accordance with the theoretical 3D model.

It may be understood that, a plurality of first positions are provided, such that precision of subsequently fitting the prism to the fitting body may be ensured.

It may be understood that, a plurality of information of the first position of the prism on the fitting body is also extracted.

In some embodiments, the information of the first position includes coordinates of the first position.

In suboperation S302, the physical 3D model and the theoretical 3D model are adjusted to an identical view angle, and the comparison data is formed by acquiring information of a second position corresponding to the first position in the physical 3D model by comparing the physical 3D model with the theoretical 3D model.

It may be understood that, in the case that the plurality of first positions are provided, a plurality of second positions are provided, and one of the second positions corresponds to one of the first positions.

In some embodiments, the information of the second position includes coordinates of the second position.

In some embodiments, the physical 3D model and the theoretical 3D model have the same scale, that is, a size of the fitting body or the prism in the physical 3D model is the same as a size of the fitting body or the prism in the theoretical 3D model. In the case that the physical 3D model and the theoretical 3D model are adjusted to the same view angle, by respectively adjusting the positions of the origins of the coordinates of the physical 3D model and the theoretical 3D model, the coordinates of the second position are the same as the coordinates of the first position, and it is convenient to subsequently control the manipulator to fit the prism to the fitting body based on the comparison data.

In operation S40, based on the comparison data, the manipulator is controlled to fit the prism at the first predetermined station to the fitting body at the second predetermined station.

Referring to FIG. 4, operation S40 further specifically includes the following suboperations.

In suboperation S401, a first distance between the prism and the second position, and information of a first movement angle of the prism relative to the second position are calculated in the physical 3D model.

The first distance between the prism and the second position may be calculated based on the coordinates of sites on the prism, and the coordinates of the second position.

The information of the first movement angle is specifically, in the physical 3D model, a moved angle when the prism is moved to the fitting body and fitted to the fitting body.

It should be noted that, in some embodiments, in the case that the first predetermined station and the second predetermined station are horizontally disposed, the first distance is the distance between the prism and the second position in a first plane parallel to the prism, and the information of the first movement angle is a moved angle when the prism is moved above the fitting body and faces the position that the prism is to be fitted to the fitting body in the first plane parallel to the prism.

In suboperation S402, the first distance is converted to a second distance in a world coordinate system.

The method for converting the first distance to the second distance in the world coordinate system is a commonly known related art, which is not described in detail herein.

In suboperation S403, the information of the first movement angle is converted to information of a second movement angle in the world coordinate system.

The method for converting information of the first movement angle to the information of the second movement angle in the world coordinate system is a commonly known related art, which is not described in detail herein.

In suboperation S404, based on the second distance and the information of the second movement angle, the manipulator is controlled to fit the prism at the first predetermined station to the fitting body at the second predetermined station.

In some embodiments, the manipulator is connected to the motorized unit, and the method for controlling the manipulator to fit the prism at the first predetermined station to the fitting body at the second predetermined station specifically includes: controlling the motorized unit, such that the motorized unit drives the manipulator to fit the prism at the first predetermined station to the fitting body at the second predetermined station.

For example, in the case that the first predetermined station and the second predetermined station are horizontally disposed, the motorized unit drives the manipulator to grasp and raise the prism; in the first plane parallel to the prism, the motorized unit drives the manipulator to move by the second distance based on the information of the second movement angle, and the motorized unit drives the manipulator to descend and release the prism, such that the prism is fitted to the fitting body.

In the embodiment of the present disclosure, scanned data is acquired by scanning a space where the prism and the fitting body are disposed in response to the prism being placed at a first predetermined station and the fitting body being placed at a second predetermined station; the physical 3D model is generated by three-dimensional reconstruction on the prism, the fitting body, and the space based on the scanned data; the comparison data is acquired by comparing the physical 3D model with the theoretical 3D model, wherein the theoretical 3D model is a theoretical model for fitting the prism to the fitting body; and based on the comparison data, the manipulator is controlled to fit the prism at the first predetermined station to the fitting body at the second predetermined station, such that the manipulator fits the prism to the fitting body with no need of manual assembly, which is very convenient. In addition, during the assembly, since the scanned data of the space where the prism and the fitting body are disposed is acquired; the physical 3D model is generated by three-dimensional reconstruction on the prism, the fitting body, and the space based on the scanned data; comparison data is acquired by comparing the physical 3D model with a theoretical 3D model; and based on the comparison data, the manipulator is controlled to fit the prism, the precision in assembling the prism to the fitting body is high, and the prism may be accurately assembled to the fitting body even the prism or the fitting body does not have a high machining precision.

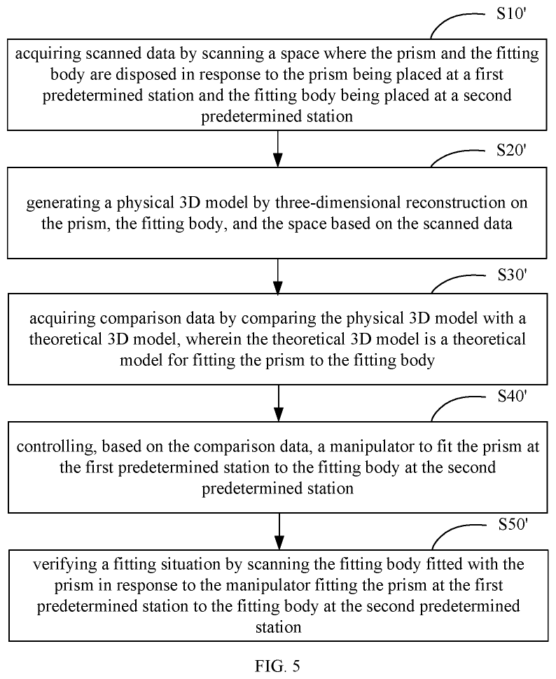

Referring to FIG. 5, FIG. 5 is a schematic flowchart of another method for assembling a prism according to an embodiment of the present disclosure. The method includes the following operations.

In operation S10′, scanned data is acquired by scanning a space where the prism and the fitting body are disposed in response to the prism being placed at a first predetermined station and the fitting body being placed at a second predetermined station.

In operation S20′, a physical 3D model is generated by three-dimensional reconstruction on the prism, the fitting body, and the space based on the scanned data.

In operation S30′, the comparison data is acquired by comparing the physical 3D model with the theoretical 3D model, wherein the theoretical 3D model is a theoretical model for fitting the prism to the fitting body.

In operation S40′, based on the comparison data, the manipulator is controlled to fit the prism at the first predetermined station to the fitting body at the second predetermined station.

In operation S50′, a fitting situation is verified by scanning the fitting body fitted with the prism in response to the manipulator fitting the prism at the first predetermined station to the fitting body at the second predetermined station.

Exemplarily, in operation S50′, another scanned data is acquired by scanning the fitting body fitted with the prism; another physical 3D model is generated by three-dimensional reconstruction on the fitting body fitted with the prism based on the another scanned data; the another physical 3D model is compared with the theoretical 3D model; and based on a comparison result, a difference between the poses of the prism and the fitting body in another physical 3D model and poses of the prism and the fitting body in the theoretical 3D model is calculated, and whether the difference is less than a predetermined value is determined; in the case that the difference is less than the predetermined value, it is determined that the prism is successfully fitted to the fitting body, and otherwise, it is determined that the prism fails to be fitted to the fitting body, and based to the comparison result, the manipulator is re-controlled to adjust fitting position of the prism on the fitting body.

A feasible method for calculating the difference between the poses of the prism and the fitting body and the poses of the prism and the fitting body in the theoretical 3D model includes: a difference between a first site on the prism and a second site on the fitting body, wherein the first site is disposed in another physical 3D model, and the second site corresponds to a site in another physical 3D model where the prism should be fitted in the theoretical 3D model.

For the method for re-controlling the manipulator to adjust the fitting position of the prism on the fitting body, reference may be made to the above embodiments, which is not described in detail herein.

In the embodiment of the present disclosure, scanned data is acquired by scanning a space where the prism and the fitting body are disposed in response to the prism being placed at a first predetermined station and the fitting body being placed at a second predetermined station; the physical 3D model is generated by three-dimensional reconstruction on the prism, the fitting body, and the space based on the scanned data; the comparison data is acquired by comparing the physical 3D model with the theoretical 3D model, wherein the theoretical 3D model is a theoretic model for fitting the prism to the fitting body; based on the comparison data, the manipulator is controlled to fit the prism at the first predetermined station to the fitting body at the second predetermined station; and a fitting situation is verified by scanning the fitting body fitted with the prism in response to the manipulator fitting the prism at the first predetermined station to the fitting body at the second predetermined station, such that the manipulator fits the prism to the fitting body with no need of manual assembly, which is very convenient. In addition, since the fitting situation is verified upon the assembly, assembly precision between the prism and the fitting body may be ensured.

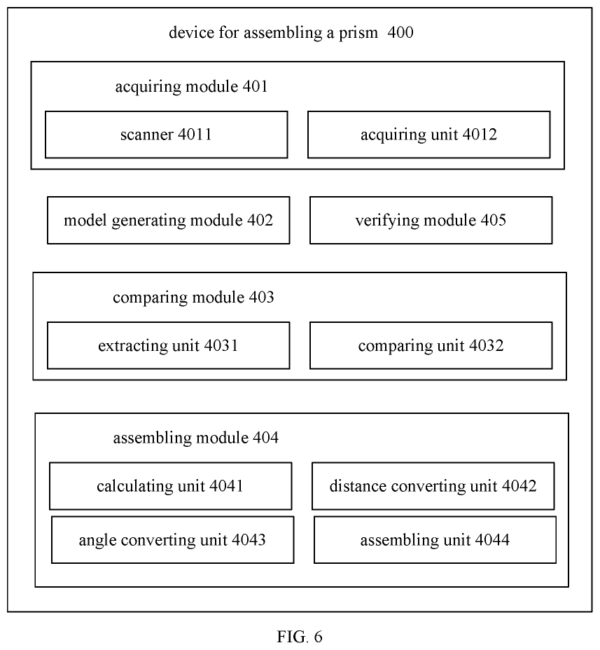

Referring to FIG. 6, FIG. 6 is a schematic diagram of a device for assembling a prism according to an embodiment of the present disclosure. A device 400 for assembling a prism is applicable to assembling the prism to a fitting body. The device 400 includes an acquiring module 401, configured to acquire scanned data by scanning a space where the prism and the fitting body are disposed in response to the prism being placed at a first predetermined station and the fitting body being placed at a second predetermined station; a model generating module 402, configured to generate a physical 3D model by three-dimensional reconstruction on the prism, the fitting body, and the space based on the scanned data; a comparing module 403, configured to acquire comparison data by comparing the physical 3D model with a theoretic 3D model, wherein the theoretic 3D model is a theoretic model for fitting the prism to the fitting body; and an assembling module 404, configured to control, based on the comparison data, a manipulator to fit the prism at the first predetermined station to the fitting body at the second predetermined station.

In some embodiments, the acquiring module 401 includes a scanner 4011, configured to scan, using a laser scanner, the space where the prism and the fitting body are disposed; and an acquiring unit 4012, configured to acquire a distance from the laser scanner to the space where the prism and the fitting body are disposed to form the scanned data.

In some embodiments, the model generating module 402 is specifically configured to generate the physical 3D model in accordance with an inverse imaging principle by three-dimensional reconstruction on the prism, the fitting body, and the space based on the distance from the laser scanner to the space where the prism and the fitting body are disposed.

In some embodiments, the comparing module 403 includes an extracting unit 4031, configured to extract information of a first position of the prism on the fitting body in accordance with the theoretic 3D model; and a comparing unit 4032, configured to adjust the physical 3D model and the theoretic 3D model to an identical view angle, and form the comparison data by acquiring information of a second position corresponding to the first position in the physical 3D model by comparing the physical 3D model with the theoretic 3D model.

In some embodiments, the assembling module 404 includes: a calculating unit 4041, configured to calculate a first distance between the prism and the second position, and information of a first movement angle between the prism and the second position in the physical 3D model; a distance converting unit 4042, configured to convert the first distance to a second distance in a world coordinate system; an angle converting unit 4043, configured to convert the information of the first movement angle to information of a second movement angle in the world coordinate system; and an assembling unit 4044, configured to control, based on the second distance and the information of the second movement angle, the manipulator to fit the prism at the first predetermined station to the fitting body at the second predetermined station.

In some embodiments, the device 400 further includes a verifying module 405, configured to verify a fitting situation by scanning the fitting body fitted with the prism in response to the manipulator fitting the prism at the first predetermined station to the fitting body at the second predetermined station.

In the embodiment of the present disclosure, scanned data is acquired by the acquiring module 401 by scanning a space where the prism and the fitting body are disposed in response to the prism being placed at a first predetermined station and the fitting body being placed at a second predetermined station; the physical 3D model is generated by the model generating module 402 by three-dimensional reconstruction on the prism, the fitting body, and the space based on the scanned data; the comparison data is acquired by the comparing module 403 by comparing the physical 3D model with the theoretic 3D model, wherein the theoretic 3D model is a theoretic model for fitting the prism to the fitting body; and based on the comparison data, the manipulator is controlled to fit the prism at the first predetermined station to the fitting body at the second predetermined station by the assembling module 404, such that the manipulator fits the prism to the fitting body with no need of manual assembly, which is very convenient. In addition, during the assembly, since the scanned data of the space where the prism and the fitting body are disposed is acquired; the physical 3D model is generated by three-dimensional reconstruction on the prism, the fitting body, and the space based on the scanned data; comparison data is acquired by comparing the physical 3D model with a theoretical 3D model; and based on the comparison data, the manipulator is controlled to fit the prism, the precision in assembling the prism to the fitting body is high, and the prism may be accurately assembled to the fitting body even the prism or the fitting body does not have a high machining precision.

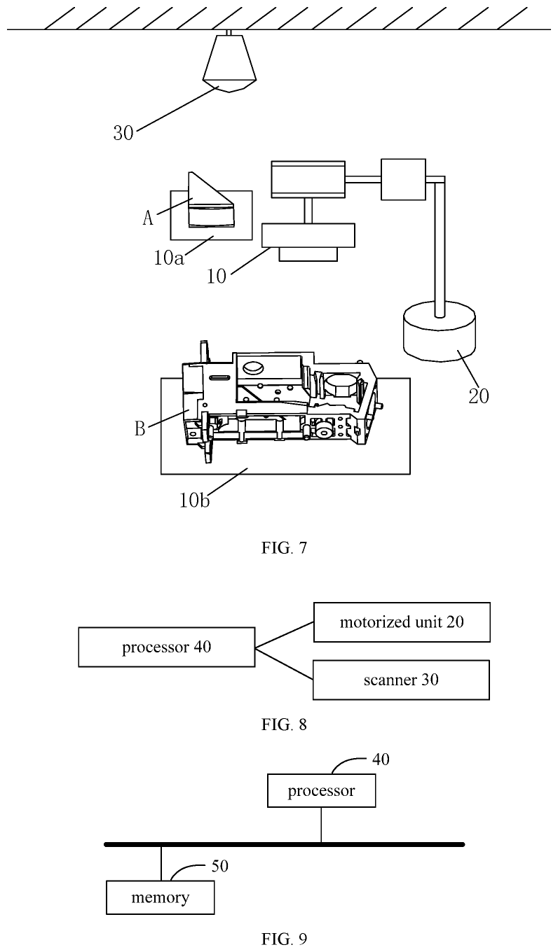

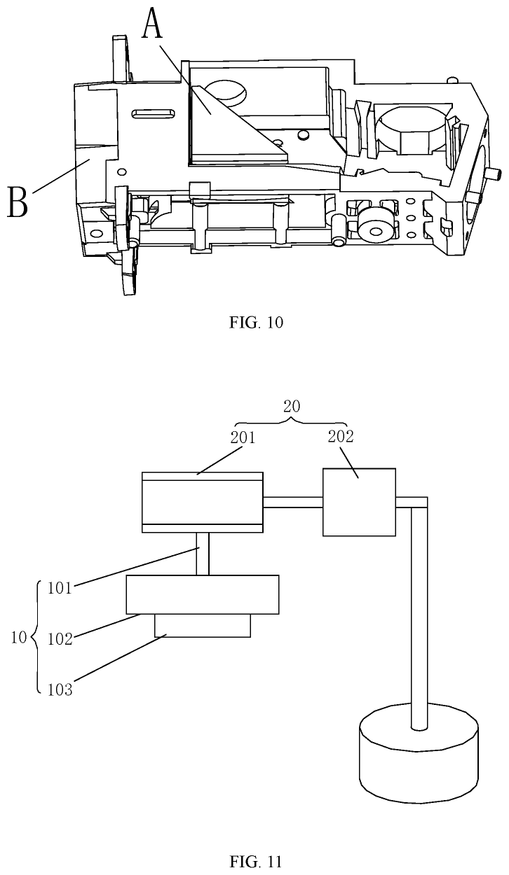

Referring to FIG. 7 to FIG. 10, an apparatus for assembling a prism A includes: a manipulator 10, a motorized unit 20, a scanner 30, at least one processor, and a memory. The manipulator 10 is configured to grasp the prism A; the motorized unit 20 is connected to the manipulator 10, and configured to drive the manipulator 10 to fit the prism A at the first predetermined station 10a to the fitting body B at the second predetermined station 10b; the scanner 30 is configured to scan the space where the prism A and the fitting body B are disposed; and both the motorized unit 20 and the scanner 30 are connected to the at least one processor; wherein the at least one processor is configured to control the motorized unit 20 to drive the manipulator 10 to fit the prism A to the fitting body B, and control the scanner to scan the space where the prism A and the fitting body B are disposed; and the memory is communicably connected to the at least one processor, wherein the memory stores one or more instructions executable by the at least one processor, wherein, the one or more instructions, when executed by the at least one processor, cause the at least one processor to perform the method for assembling the prism A.

With respect to the motorized unit 20, referring to FIG. 7 and FIG. 11, the motorized unit 20 includes a first driving member 201 and a second driving member 202; wherein the first driving member 201 is connected to the manipulator 10, and configured to drive the manipulator 10 to move along a first direction, wherein the first direction is perpendicular to a surface, distal from the first predetermined station 10a, of the prism A; and the second driving member 202 is connected to the first driving member 201, and configured to drive the first driving member 201 to move in a first plane, wherein the first plane is perpendicular to the first direction.

In some embodiments, after the manipulator 10 grasps the prism A at the first predetermined station 10a, the first driving member 201 drives the manipulator 10 to move away from the first predetermined station 10a along the first direction, and the prism A is distal from the first predetermined station 10a; and the second driving member 202 drives the first driving member 201 to move in a first plane, the manipulator 10 drives the prism A to move in the first plane, and when the prism A moves to the fitting body B, the first driving member 201 drives the manipulator 10 to move proximally to the fitting body B along the first direction, the manipulator 10 releases the prism A, and the prism A is fitted to the fitting body B.

The first driving member 201 includes a cylinder, and the first driving member 201 may be a driving member commonly known in the related art, which is not described in detail herein.

The second driving member 202 includes a combination of a cylinder and a turntable, and the second driving member 202 may be a driving member commonly known in the related art, which is not described in detail herein.

With respect to the manipulator 10, referring to FIG. 11, the manipulator 10 includes a connection arm 101, a vacuum generator 102, and a vacuum cup 103; wherein one end of the connection arm 101 is connected to the first driving member 201 and the other end of the connection arm is connected to the vacuum generator 102, and the vacuum generator 102 is further connected to the vacuum cup 103; and the vacuum generator 102 is further connected to the processor, and the processor is further configured to control the vacuum generator 102 to operate such that the vacuum cup 103 suctions the prism A.

In some embodiments, the scanner 30 is a laser scanner 30.

In some embodiments, the scanner 30 is disposed on a ceiling.

The processor 40 and the memory 50 may be connected via a bus or in another manner, and referring to FIG. 8, the embodiments of the present disclosure use the bus as an example.

The memory 50, as a non-volatile computer readable storage medium, may be configured to store non-volatile software programs, non-volatile computer executable programs and modules, for example, the program instructions/modules corresponding to the methods for assembling the prism A in the embodiments of the present disclosure (for example, the modules as illustrated in FIG. 6). The non-volatile software programs, instructions and modules stored in the memory 50, when being executed, cause the processor 40 to perform various function applications and data processing of the device for assembling the prism A, that is, performing the methods for assembling the prism A according to the above method embodiments.

The memory 50 may include a program memory area and data memory area, wherein the program memory area may store operation systems and application programs needed by at least function; and the data memory area may store data created according to the usage of the devices for assembling the prism A. In addition, the memory 50 may include a high-speed random-access memory, or include a non-volatile memory, for example, at least one disk storage apparatus, a flash memory apparatus, or another non-volatile solid storage apparatus. In some embodiments, the memory 50 optionally includes memories remotely configured relative to the processor 40. These memories may be connected to the device for assembling the prism A over a network. Examples of the above network include, but not limited to, the Internet, Intranet, local area network, mobile communication network and a combination thereof.

One or more modules are stored in the memory 50, and when being executed by the at least one processor 40, perform the method for assembling the prism A in any of the above method embodiments.

The product may perform the method according to the embodiments of the present disclosure, has corresponding function modules for performing the method, and achieves the corresponding beneficial effects. For technical details that are not illustrated in detail in this embodiment, reference may be made to the description of the methods according to the embodiments of the present disclosure.

An embodiment of the present disclosure provides a non-volatile computer-readable storage medium, wherein the non-volatile computer-readable storage medium stores one or more computer-executable instructions. The one or more computer-executable instructions, when executed by an electronic apparatus, cause the electronic apparatus to perform the method for assembling the prism in any of the above method embodiments.

An embodiment of the present disclosure further provides a computer program product. The computer program product includes one or more computer programs stored in a non-volatile computer-readable storage medium. The one or more computer programs include one or more program instructions. The one or more program instructions, when executed by a computer, cause the computer to perform the method for assembling the prism in any of the above embodiments.

The above described device embodiments are merely for illustration purpose only. The units which are described as separate components may be physically separated or may be not physically separated, and the components which are illustrated as units may be or may not be physical units, that is, the components may be located in the same position or may be distributed into a plurality of network units. Part or all of the modules may be selected according to the actual needs to achieve the objects of the technical solutions of the embodiments.

According to the above embodiments of the present disclosure, a person skilled in the art may clearly understand that the embodiments of the present disclosure may be implemented by means of hardware or by means of software plus a necessary general hardware platform. Persons of ordinary skill in the art may understand that all or part of the operations of the methods in the embodiments may be implemented by a program instructing relevant hardware. The program may be stored in a computer-readable storage medium. When the program runs, the operations of the methods in the embodiments are performed. The storage medium may be any medium capable of storing program codes, such as read-only memory (ROM), a random-access memory (RAM), a magnetic disk, or a compact disc read-only memory (CD-ROM).

Finally, it should be noted that, the above embodiments are merely used to illustrate the technical solutions of the present disclosure rather than limiting the technical solutions of the present disclosure. Under the concept of the present disclosure, the technical features of the above embodiments or other different embodiments may be combined, the operations therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

1. A method for assembling a prism, applicable to assembling the prism to a fitting body, the method comprising:
acquiring scanned data by scanning a space where the prism and the fitting body are disposed in response to the prism being placed at a first predetermined station and the fitting body being placed at a second predetermined station;
generating a physical 3D model by three-dimensional reconstruction on the prism, the fitting body, and the space based on the scanned data;
acquiring comparison data by comparing the physical 3D model with a theoretical 3D model, wherein the theoretical 3D model is a theoretical model for fitting the prism to the fitting body; and
controlling, based on the comparison data, a manipulator to fit the prism at the first predetermined station to the fitting body at the second predetermined station.

2. The method according to claim 1, wherein acquiring the scanned data by scanning the space where the prism and the fitting body are disposed in response to the prism being placed at the first predetermined station and the fitting body being placed at the second predetermined station comprises:
scanning, using a laser scanner, the space where the prism and the fitting body are disposed; and
forming the scanned data by acquiring a distance from the laser scanner to the space where the prism and the fitting body are disposed.

3. The method according to claim 2, wherein generating the physical 3D model by three-dimensional reconstruction on the prism, the fitting body, and the space based on the scanned data comprises:
generating the physical 3D model in accordance with an inverse imaging principle by three-dimensional reconstruction on the prism, the fitting body, and the space based on the distance from the laser scanner to the space where the prism and the fitting body are disposed.

4. The method according to claim 3, wherein acquiring the comparison data by comparing the physical 3D model with the theoretical 3D model comprises:
extracting information of a first position of the prism on the fitting body in accordance with the theoretical 3D model; and
adjusting the physical 3D model and the theoretical 3D model to an identical view angle, and forming the comparison data by acquiring information of a second position corresponding to the first position in the physical 3D model by comparing the physical 3D model with the theoretical 3D model.

5. The method according to claim 4, wherein controlling, based on the comparison data, the manipulator to fit the prism at the first predetermined station to the fitting body at the second predetermined station comprises:
calculating a first distance between the prism and the second position, and information of a first movement angle of the prism relative to the second position in the physical 3D model;
converting the first distance to a second distance in a world coordinate system;
converting the information of the first movement angle to information of a second movement angle in the world coordinate system; and
controlling, based on the second distance and the information of the second movement angle, the manipulator to fit the prism at the first predetermined station to the fitting body at the second predetermined station.

6. The method according to claim 1, further comprising:
verifying a fitting situation by scanning the fitting body fitted with the prism in response to the manipulator fitting the prism at the first predetermined station to the fitting body at the second predetermined station.

7. A device for assembling a prism, applicable to assembling the prism to a fitting body, the device comprising:
an acquiring module, configured to acquire scanned data by scanning a space where the prism and the fitting body are disposed in response to the prism being placed at a first predetermined station and the fitting body being placed at a second predetermined station;
a model generating module, configured to generate a physical 3D model by three-dimensional reconstruction on the prism, the fitting body, and the space based on the scanned data;
a comparing module, configured to acquire comparison data by comparing the physical 3D model with a theoretical 3D model, wherein the theoretical 3D model is a theoretical model for fitting the prism to the fitting body; and
an assembling module, configured to control, based on the comparison data, a manipulator to fit the prism at the first predetermined station to the fitting body at the second predetermined station.

8. The device according to claim 7, wherein the acquiring module comprises:
a scanner, configured to scan, using a laser scanner, the space where the prism and the fitting body are disposed; and
an acquiring unit, configured to acquire a distance from the laser scanner to the space where the prism and the fitting body are disposed to form the scanned data.

9. The device according to claim 8, wherein the model generating module is configured to generate the physical 3D model in accordance with an inverse imaging principle by three-dimensional reconstruction on the prism, the fitting body, and the space based on the distance from the laser scanner to the space where the prism and the fitting body are disposed.

10. The device according to claim 7, wherein the comparing module comprises:
an extracting unit, configured to extract information of a first position of the prism on the fitting body in accordance with the theoretical 3D model; and
a comparing unit, configured to adjust the physical 3D model and the theoretical 3D model to an identical view angle, and form the comparison data by acquiring information of a second position corresponding to the first position in the physical 3D model by comparing the physical 3D model with the theoretical 3D model.

11. The device according to claim 7, wherein the assembling module comprises:
a calculating unit, configured to calculate a first distance between the prism and the second position, and information of a first movement angle of the prism relative to the second position in the physical 3D model;
a distance converting unit, configured to convert the first distance to a second distance in a world coordinate system;
an angle converting unit, configured to convert information of the first movement angle to information of a second movement angle in the world coordinate system; and
an assembling unit, configured to control, based on the second distance and the information of the second movement angle, the manipulator to fit the prism at the first predetermined station to the fitting body at the second predetermined station.

12. The device according to claim 7, wherein the device further comprises:
a verifying module, configured to verify a fitting situation by scanning the fitting body fitted with the prism in response to the manipulator fitting the prism at the first predetermined station to the fitting body at the second predetermined station.

13. An apparatus for assembling a prism, configured to assemble the prism to a fitting body, the apparatus comprising:
a manipulator, configured to grasp the prism;
a motorized unit, connected to the manipulator, and configured to drive the manipulator to fit the prism at a first predetermined station to the fitting body at a second predetermined station;
a scanner, configured to scan a space where the prism and the fitting body are disposed;
at least one processor, connected to both the motorized unit and the scanner, wherein the at least one processor is configured to control the motorized to drive the manipulator to fit the prism to the fitting body, and control the scanner to scan the space where the prism and the fitting body are disposed; and
a memory, communicably connected to the at least one processor, wherein the memory stores one or more instructions executable by the at least one processor, wherein, the one or more instructions, when executed by the at least one processor, cause the at least one processor to perform following operations:
acquiring scanned data by scanning the space where the prism and the fitting body are disposed in response to the prism being placed at the first predetermined station and the fitting body being placed at the second predetermined station;
generating a physical 3D model by three-dimensional reconstruction on the prism, the fitting body, and the space based on the scanned data;
acquiring comparison data by comparing the physical 3D model with a theoretical 3D model, wherein the theoretical 3D model is a theoretical model for fitting the prism to the fitting body; and
controlling, based on the comparison data, the manipulator to fit the prism at the first predetermined station to the fitting body at the second predetermined station.

14. The apparatus according to claim 13, wherein acquiring the scanned data by scanning the space where the prism and the fitting body are disposed in response to the prism being placed at the first predetermined station and the fitting body being placed at the second predetermined station comprises:
scanning, using a laser scanner, the space where the prism and the fitting body are disposed; and
forming the scanned data by acquiring a distance from the laser scanner to the space where the prism and the fitting body are disposed.

15. The apparatus according to claim 14, wherein generating the physical 3D model by three-dimensional reconstruction on the prism, the fitting body, and the space based on the scanned data comprises:
generating the physical 3D model in accordance with an inverse imaging principle by three-dimensional reconstruction on the prism, the fitting body, and the space based on the distance from the laser scanner to the space where the prism and the fitting body are disposed.

16. The apparatus according to claim 15, wherein acquiring the comparison data by comparing the physical 3D model with the theoretical 3D model comprises:
extracting information of a first position of the prism on the fitting body in accordance with the theoretical 3D model; and
adjusting the physical 3D model and the theoretical 3D model to an identical view angle, and forming the comparison data by acquiring information of a second position corresponding to the first position in the physical 3D model by comparing the physical 3D model with the theoretical 3D model.

17. The apparatus according to claim 16, wherein controlling, based on the comparison data, the manipulator to fit the prism at the first predetermined station to the fitting body at the second predetermined station comprises:
calculating a first distance between the prism and the second position, and information of a first movement angle of the prism relative to the second position in the physical 3D model;
converting the first distance to a second distance in a world coordinate system;
converting the information of the first movement angle to information of a second movement angle in the world coordinate system; and
controlling, based on the second distance and the information of the second movement angle, the manipulator to fit the prism at the first predetermined station to the fitting body at the second predetermined station.

18. The apparatus according to claim 13, wherein the at least one processor is further caused to perform following operation:
verifying a fitting situation by scanning the fitting body fitted with the prism in response to the manipulator fitting the prism at the first predetermined station to the fitting body at the second predetermined station.

19. The apparatus according to claim 13, wherein
the motorized unit comprises a first driving member and a second driving member;
the first driving member is connected to the manipulator, and configured to drive the manipulator to move along a first direction, wherein the first direction is perpendicular to a surface, distal from the first predetermined station, of the prism; and
the second driving member is connected to the first driving member, and configured to drive the first driving member to move in a first plane, wherein the first plane is perpendicular to the first direction.

20. The apparatus according to claim 19, wherein
the manipulator comprises a connection arm, a vacuum generator, and a vacuum cup;
wherein one end of the connection arm is connected to the first driving member and the other end of the connection arm is connected to the vacuum generator, and the vacuum generator is further connected to the vacuum cup; and
the vacuum generator is further connected to the processor, and the processor is further configured to control the vacuum generator to operate such that the vacuum cup suctions the prism.
